(19) United States
(12) Patent Application Publication
(10) Pub. No.: US 2012/0121201 A1
(43) Pub. Date: May 17, 2012

(54) IMAGE PROCESSING APPARATUS AND IMAGE PROCESSING METHOD

(75) Inventor: Akira Ichimura, Tokyo (JP)

(73) Assignee: CANON KABUSHIKI KAISHA, Tokyo (JP)

(21) Appl. No.: 13/276,724

(22) Filed: Oct. 19, 2011

(30) Foreign Application Priority Data
Nov. 16, 2010 (JP) 2010-256004

(51) Int. Cl. G06K 9/38

(52) U.S. Cl. 382/252

(57) ABSTRACT

M-value image data is inputted; a value of a pixel of interest in the inputted image data is quantized to N(N>M) value by an error diffusion method; it is determined whether both of a value of the pixel of interest to be quantized and an error value to be added to the pixel of interest are zero; and if it is determined that the value of the pixel of interest and the error value are zero, zero is outputted as a quantization result without performing quantization by the error diffusion method.

### BACKGROUND OF THE INVENTION

1. Field of the Invention

The present invention relates to an image processing apparatus and an image processing method for processing image data by an error diffusion method.

2. Description of the Related Art

It is conventionally well known that, in printing images etc., inputted M-value image data is converted to N-value (N<M) image data by pseudo-gradation processing.

An error diffusion method, which is one of pseudo-gradation processing, is excellent in resolution and gradation, but is difficult to be speeded up because it requires processing based on the result of diffusion of an error of a previous pixel. Japanese Patent Laid-Open No. 2002-209105 and Japanese Patent Laid-Open No. 2000-177178 disclose a method in which when inputted image data fulfills a certain condition, a gradation value to be outputted is generated by a method other than the error diffusion method, thereby performing image processing in high speed.

In the method disclosed in the aforementioned publications, only inputted pixel value is paid attention to. Therefore, there is a problem that, in a high speed mode in which an outputted gradation value is generated by a method other than the error diffusion processing, diffusion processing of an error value from a peripheral pixel is not performed. As a result, a density of inputted image data may not be maintained, causing degradation of image quality.

### SUMMARY OF THE INVENTION

One aspect of the present invention is to provide an image processing apparatus and an image processing method that solve the aforementioned problem of the conventional method. Another aspect of the present invention is to provide an image processing apparatus and an image processing method that allow for high-speed processing and high image quality. Further aspects of the present invention will be apparent from detailed description below with reference to drawings.

First aspect of the present invention provides an image processing, including:

an input unit configured to input M-value image data;

a quantization unit configured to quantize a value of a pixel of interest in the image data inputted by the input unit to N(N<M) value by an error diffusion method;

a determination unit configured to determine whether or not both of a value of a pixel of interest to be quantized by the quantization unit and an error value to be added to the pixel of interest are zero; and

if the determination unit determines that both of the value of the pixel of interest and the error value are zero, an output unit configured to output zero as a quantization result without performing quantization by the quantization unit.

Second aspect of the present invention provides an image processing method, including:

inputting M-value image data;

quantizing a value of a pixel of interest in the inputted image data to N(N>M) value by an error diffusion method;

determining whether or not both of a value of the pixel of interest to be quantized and an error value to be added to the pixel of interest are zero; and

if it is determined that the value of the pixel of interest and the error value are zero, outputting zero as a quantization result without performing quantization by the error diffusion method.

Third aspect of the present invention provides a non-transitory computer-readable storage medium which stores a computer-executable program for performing a following method, the method including:

inputting M-value image data;

quantizing a value of a pixel of interest in the inputted image data to N(Z>M) value by an error diffusion method;

determining whether or not both a value of the pixel of interest to be quantized and an error value to be added to the pixel of interest are zero; and

if it is determined that the value of the pixel of interest and the error value are zero, outputting zero as a quantization result without performing quantization by the error diffusion method.

Further features of the present invention will become apparent from the following description of exemplary embodiments (with reference to the attached drawings).

### BRIEF DESCRIPTION OF THE DRAWINGS

FIG. 1 is a functional block diagram illustrating a configuration of an ink jet printing device;

FIG. 2 is a functional block diagram illustrating a configuration of an image processing unit;

FIG. 3 is a diagram illustrating an error diffusion matrix;

FIGS. 4A to 4C are conceptual diagrams illustrating a method for accumulating methods;

FIG. 5 is a flow chart illustrating an overview of image data processing;

FIG. 6 is a block diagram illustrating a configuration of a quantization processing unit;

FIG. 7 is a flow chart illustrating detailed procedures of quantization processing; and

FIG. 8 is a block diagram illustrating a configuration of a quantization processing unit according to another embodiment.

### DESCRIPTION OF THE EMBODIMENTS

Embodiments according to the present invention will be described with reference to the drawings. In this specification, “printing” is defined as forming not only meaningful information such as characters and graphics but also meaningless information. Printing is also defined broadly as: forming images, patterns, etc., on a printing medium, regardless whether they are explicit to be visually perceived by humans, or processing a print medium. “A print medium” means not only paper that is used in a common printing device, but also a medium for which ink can be used, broadly such as a cloth, plastic film, metal sheet, glass, ceramics, wood and leather. “Ink” shall be broadly interpreted as with the aforementioned definition of “printing”. That is, ink means a liquid that, by applying the liquid to a print medium, forms images, patterns, etc., processes the print medium or processes ink (for example, solidifying or insolubilizing a coloring material in ink applied to the print medium).

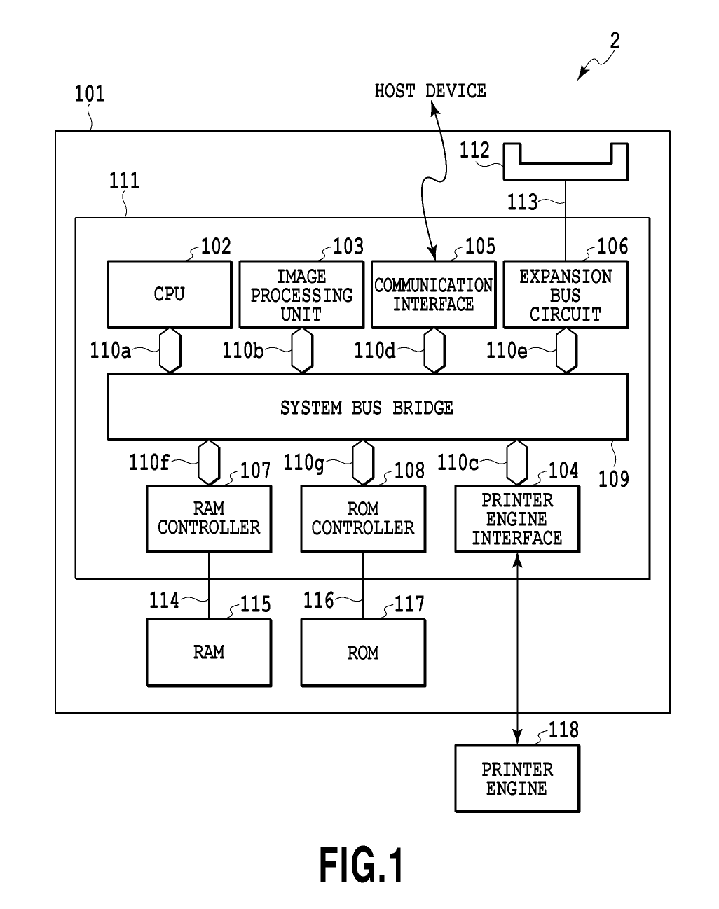

FIG. 1 is a block diagram illustrating a configuration of a printing device according to an embodiment of the present invention. As illustrated in FIG. 1, a printing device 2 has an image forming controller 101 and a printer engine 118.

The image forming controller 101 receives a print instruction and image data for printing from a host device such as a personal computer, converts the received image data into binary image data in a configuration that can be printed by the printer engine 118 and outputs the binary image data. The image forming controller 101 includes a CPU 102, an image processing unit 103, a printer engine interface 104, a communication interface 105, an expansion bus circuit 106, a RAM controller 107 and a ROM controller 108. Furthermore, these blocks are connected respectively through bus lines 110a to 110g to a system bus bridge 109. In this embodiment, these blocks are realized as an ASIC 111 sealed to one package as a system LSI. The image forming controller 101 also includes an expansion slot 112 to which a functionality expansion unit is loaded, a RAM 115 and a ROM 117.

The CPU 102 controls the entire image forming controller 101. The CPU 102 reads out a control program stored in the ROM 117, loads the control program to the RAM 115 to be executed, and controls the image processing unit 103 for converting image data received from the host device into image forming data that is binary image data. The CPU 102 also controls the communication interface 105 for communicating to the host device, interprets a communication protocol, and controls the printer engine interface 104 for transferring image forming data generated in the image processing unit 103 to the printer engine 118.

The image processing unit 103 has a function of converting image data received from the host device to binary image data per pixel, which is used for processing in printing image in the printer engine 118. Detailed configuration of the image processing unit 103 will be described later with reference to drawings.

The printer engine interface 104 sends and receives data between the image forming controller 101 and the printer engine 118. The printer engine interface 104 has a direct memory access controller (DMAC), sequentially reads out binary image data generated in the image processing unit 103 and stored in the RAM 115 via the RAM controller 107, and transfers the read out binary image data to the printer engine 118.

The communication interface 105 sends and receives data to and from a host device such as a personal computer and a workstation, and stores image data received from the host device into the RAM 115 via the RAM controller 107. The communication interface 105 is compatible with a wired communication protocol or a wireless communication protocol.

The expansion bus circuit 106 has a function of controlling the functionality expansion unit loaded to the expansion slot 112, and controls sending data to the functionality expansion unit through an expansion bus 113 and receiving data outputted by the functionality expansion unit. To the expansion slot 112, a communication unit that provides communication function, a hard disc drive unit that provides mass storage function and so on can be loaded. The image processing unit 103, communication interface 105 and expansion bus circuit 106 have a DMAC as with the printer engine interface 104, and have a function of issuing a memory access request.

The RAM controller 107 has a function of controlling the RAM 115 connected through the RAM bus 114 to the ASIC 111. The RAM controller 107 relays data that is written or read out between the CPU 102, each block having the DMAC, and the RAM 115. The RAM controller 107 generates a necessary control signal according to a readout request or a writing request from the CPU 102 and each block, and realizes writing to the RAM 115 or readout from the RAM 115.

The ROM controller 108 has a function of controlling the ROM 117 connected through the ROM bus 116 to the ASIC 111. The ROM controller 108 generates a necessary control signal according to a readout request from the CPU 102, reads out a program or data previously stored in the ROM 117, and sends the read out content back through the system bus bridge 109 to the CPU 102. If the ROM 117 is composed of a device that is electrically rewritable such as a flash memory, the ROM controller 108 has a function of generating a necessary control signal to rewrite the content of the ROM 117.

The system bus bridge 109 has a function of connecting the respective blocks composing the ASIC 111, and also has a function of adjusting a bus right if the plurality of blocks issue an access request at the same time. In some cases, the CPU 102 and the each block having the DMAC issue an access request via the RAM controller 107 to the RAM 115 almost at the same time. In these cases, the system bus bridge 109 properly performs adjustment in order of predetermined priority.

The RAM 115 is composed of, e.g., a synchronous DRAM, and provides functions as temporarily stored a program to be executed by the CPU 102, temporarily stored image forming data generated in the image processing unit 103, and a work memory in the CPU 102. The RAM 115 has functions of temporary buffering of image data the communication interface 105 receives from the host device, as well as temporary storage for data sent to or received from the functionality expansion unit connected through the expansion bus 113.

The ROM 117 is composed of, e.g., a flash memory, and stores parameters necessary for a program executed by the CPU 102 and printer control. A flash memory is a device that is electrically rewritable and nonvolatile, and therefore a program and a parameter can be rewritten according to a designated sequence.

In addition, each circuit block includes a register for setting an operation mode and so on, and the CPU 102 can set the operation mode and so on for the each circuit block through a register access bus.

The printer engine 118 is a printing mechanism that makes a print head print an image on a print medium, based on binary image data sent from the image forming controller 101. According to the present embodiment, the printer engine 118 performs ink jet printing. That is, four color inks of cyan (C), magenta (M), yellow (Y) and black (Bk) are ejected on a print medium from a print head according to binary image data, thereby printing an image.

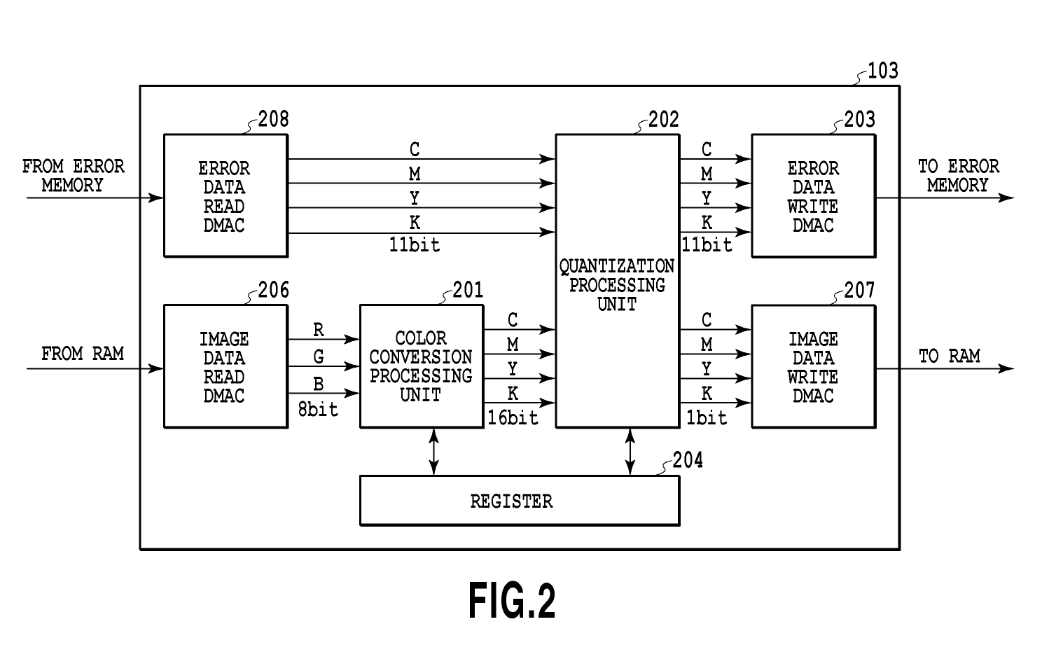

Next, the image processing unit 103 in the printing device will be described with reference to drawings. FIG. 2 is a functional block diagram illustrating a detailed configuration of the image processing unit 103.

The image processing unit 103 includes a color conversion processing unit 201, a quantization processing unit 202, a register 204, a DMAC 206 for reading image data, a DMAC 207 for writing image data, a DMAC 208 for reading error data, and a DMAC 203 for writing error data.

The color conversion processing unit 201 converts a color space of inputted multi-value (M-value) image data per pixel in a line format received from the host device to a color space represented by ink colors of the printer engine 118. In the present embodiment, the multivalued image data from the host device is color image data in which each pixel is represented by eight bits (256 values) for each of red (R), green (G), blue (B). The color conversion processing unit 201 converts each pixel of this inputted image data to a color space represented by 16 bits for each of C, M, Y, K that is ink colors of the printer engine 118. The color conversion processing unit 201 also performs gamma correction according to an output characteristic of the printer engine 118.

The quantization processing unit 202 performs binarization (N-value) processing on each color component by the error diffusion method. The quantization processing unit 202 adds an error diffused from a peripheral pixel to a pixel of interest, and then comparing the pixel value added with the error with a threshold value, thereby performing binarization processing, that is, quantization processing. If the pixel value added with the error is greater than the threshold value, it becomes one (a dot is on). If the pixel added with the error is not greater than the threshold value, it becomes zero (a dot is off). A quantization error (a difference from the threshold value) that occurs at this time is diffused to a peripheral unprocessed pixel, thereby maintaining a density of the entire image data. The error data is sent to the DMAC 203, stored in the error memory and sent to the quantization processing unit 202 via the DMAC 208.

The register 204 is composed of a group of registers, including an image processing start-up register for instructing start of image processing and a command/parameter register for specifying content of image processing to be executed and a parameter. The register 204 has a register for setting a parameter relating to a threshold value for quantization.

The DMAC 206 is for reading out inputted image data stored in the RAM 115. The DMAC 207 is for storing binary image data that is generated by performing quantization processing on the inputted image data, in the RAM 115.

The DMAC 208 is for reading out error data diffused from a neighboring line, from an error memory. The DMAC 209 is for storing error data diffusing to a neighboring line in the error memory. In this embodiment, the error memory is configured as part of the RAM 115.

Operation of the quantization processing unit 202 will be described in detail. The quantization processing unit 202 reads out diffusion error data from a previous line and adds the diffusion error data to image data of a pixel of interest outputted from the color conversion processing unit 201. A diffusion error data from a previous line is stored in the RAM 115. The error data read out from the RAM 115 is sent to the quantization processing unit 202. To the pixel of interest, a diffusion error from a processed pixel in a same line is also added. A diffusion error from a same line is temporarily stored in a buffer 905 (will be described later) in the quantization processing unit 202. After the errors are diffused from the same line and the previous line, quantization is performed by comparing the value with the threshold value for each color component, and outputted data is stored in the RAM 115 via the DMAC 207.

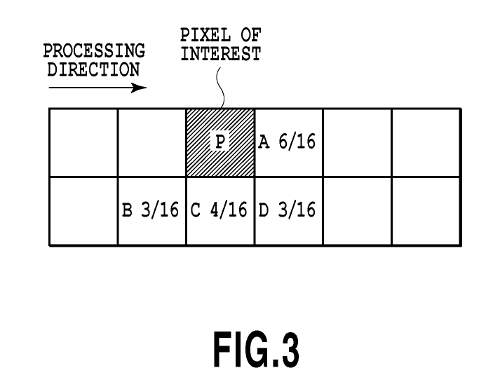

FIG. 3 illustrates an error diffusion matrix to be used for error diffusion processing. In FIG. 3, a pixel indicated by “P” is a pixel of interest. A quantization error that occurs by quantization processing is diffused to peripheral unprocessed pixels according to a diffusion coefficient illustrated in FIG. 3. Of this diffusion, a diffusion error to the same line indicated by “A” in FIG. 3 is stored in the buffer 905 in the quantization processing unit 202. Diffusion errors to the neighboring line indicated by “B”, “C” and “D” in FIG. 3 are temporarily stored in the buffer in the quantization processing unit 202, and all diffusion errors diffused to the same pixel are summed up. The summed diffusion error is stored into the RAM 115 via an error data write DMAC 209.

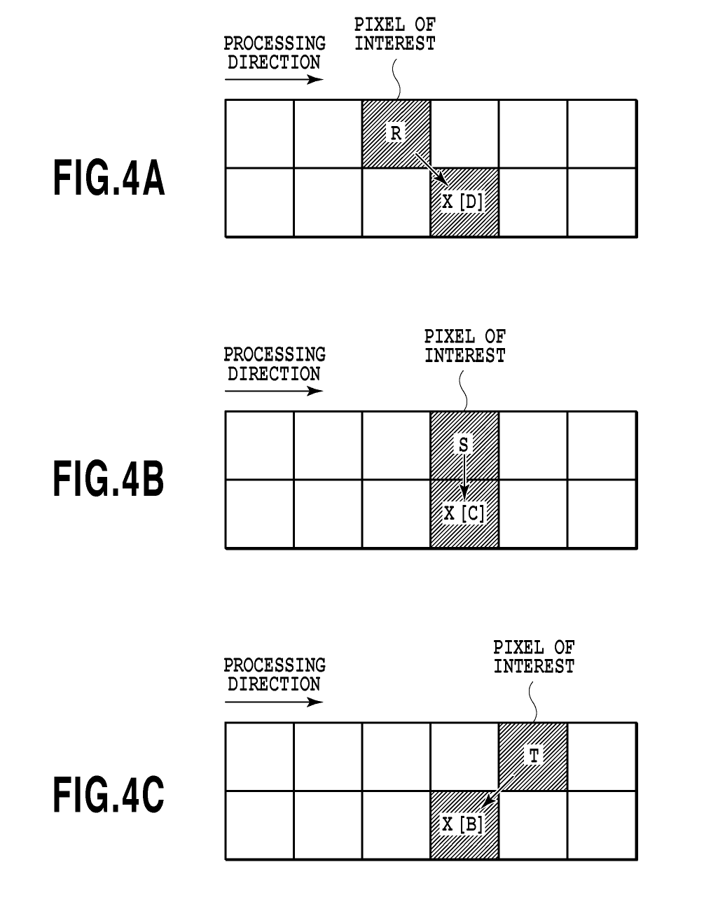

FIGS. 4A to 4C schematically illustrate an error diffusion. In FIGS. 4A to 4C, a diffusion error to a pixel indicated by “X” is the sum of the following three diffusion errors: a diffusion error from a pixel of interest “R” in FIG. 4A to a pixel whose diffusion coefficient is “D” in FIG. 3; a diffusion error from a pixel of interest “S” in FIG. 4B to a pixel whose diffusion coefficient is “C”; and a diffusion error from a pixel of interest “T” in FIG. 4C to a pixel whose diffusion coefficient is “B”.

When the image processing unit 103 is instructed to start image processing by writing from the CPU 102 to the register 204, the image processing unit 103 reads out image data stored in the RAM 115 sequentially from a pixel at one end to a pixel at the other end, and subjects the image data to the aforementioned color conversion processing and quantization processing. After a line processing is completed, the image processing unit 103 issues an interruption to the CPU 102 to notify completion of processing. By an instruction from the CPU 102, the same processing is performed to pixel lines adjacent to each other in a vertical scanning direction, thereby realizing binarization processing of the entire image data. Binarized outputted image data is sequentially stored into the RAM 115. This data is sent to the printer engine 118 via the printer engine interface 104, thereby performing printing on a print medium. Although one direction is illustrated as a processing direction in FIGS. 3, 4A, 4B, and 4C, processing in the opposite direction is possible and the processing direction can be switched alternately.

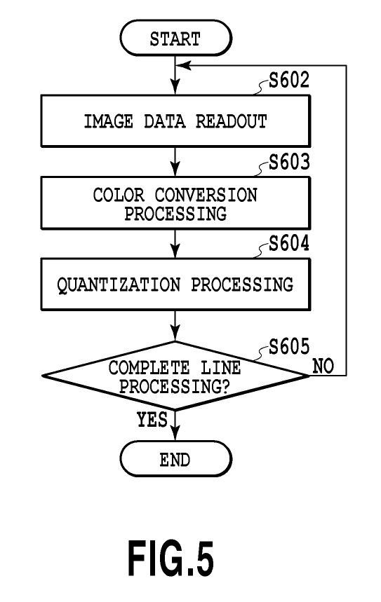

Operation of a printing device according to the present embodiment will be described in detail. FIG. 5 is a flow chart illustrating operational procedures of the image processing unit in the case where the printing device subjects image data to quantization processing. When the image processing unit 103 is instructed to perform quantization processing, the image processing unit 103 performs an image processing operation according to the flow chart in FIG. 5, thereby performing quantization processing.

At step S602, an image processing unit 601 reads out image data of a pixel of interest from the RAM 115 via the DMAC 206.

Next, at step S603, the color conversion processing unit 201 in the image processing unit 103 converts the pixel of interest to image data represented by ink colors.

Then, at step S604, the image processing unit 103 quantizes image data of the pixel of interest for each color component C, M, Y, K by the error diffusion method. The quantization processing at this step will be described later in detail with reference to drawings.

At step S605, the image processing unit 103 determines whether image processing for one line has been completed or not; if an unprocessed pixel remains, processing returns to step S601; and if all pixels for one line have been processed, processing is terminated.

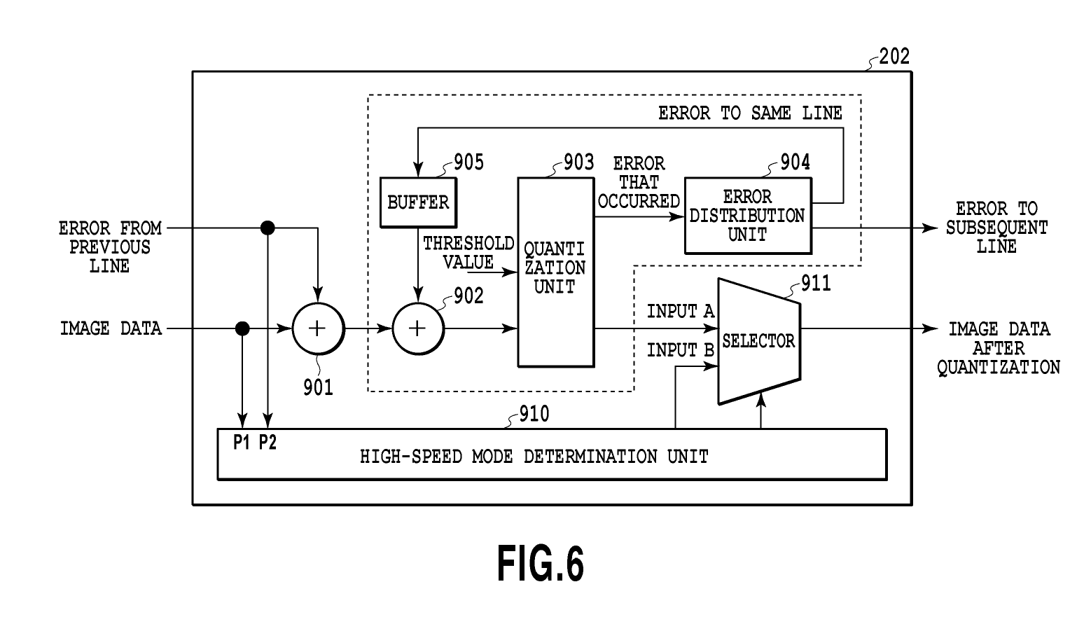

Next, with reference to FIG. 6, configuration of the quantization processing unit 202 in the image processing unit 103 will be described in detail. FIG. 6 is a detailed block diagram of the quantization processing unit. An addition unit 901 adds error data from a previous line that is inputted from the error memory via the DMAC 208 and image data that is inputted from the RAM via the DMAC 206 and the color conversion processing unit 201.

An addition unit 902 adds the value from the addition unit 901 and an error value A distributed from a previous pixel. A quantization unit 903 quantizes the value from the addition unit 902 to a binary on the basis of a threshold value stored in the register 204. An error that occurs in quantization is sent to an error distribution unit 904, and distributed to a same line and a subsequent line, as illustrated in FIGS. 3, 4A, 4B and 4C. An error to the same line is stored in the buffer 905 to be used in processing a subsequent pixel. A quantized result is outputted as the quantized image data via a selector 911. The error distribution unit 904 includes a register to hold a cumulative value of errors in order to distribute the errors to a subsequent line. This register includes a memory region that holds errors accumulated at each pixel position, since the errors are distributed from one pixel of interest to three pixels on a subsequent line as illustrated in FIG. 3. After errors are accumulated (addition of errors “B”, “C”, “D” is completed) for one pixel position, the accumulated error is outputted to the error memory.

A high-speed mode determination unit 910 determines whether to disable functions of quantization and error distribution to output a predetermined quantized image data. The high-speed mode determination unit 910 determines whether an image data input value P1 is zero or not and whether an error value P2 obtained from a previous line is zero or not, and performs input switching control of the selector 911. If at least one of the input value P1 and the error value P2 is other than zero, input A of the selector 911 is selected and quantization by the quantization unit 903 is performed. If both of the input value P1 and the error value P2 are zero, input B of the selector 911 is selected and quantization by the quantization unit 903 is disabled and a predetermined quantization result is inputted. For input B, as image data after quantization in the high-speed mode, zero that is the predetermined quantization result is outputted from the high-speed mode determination unit 910.

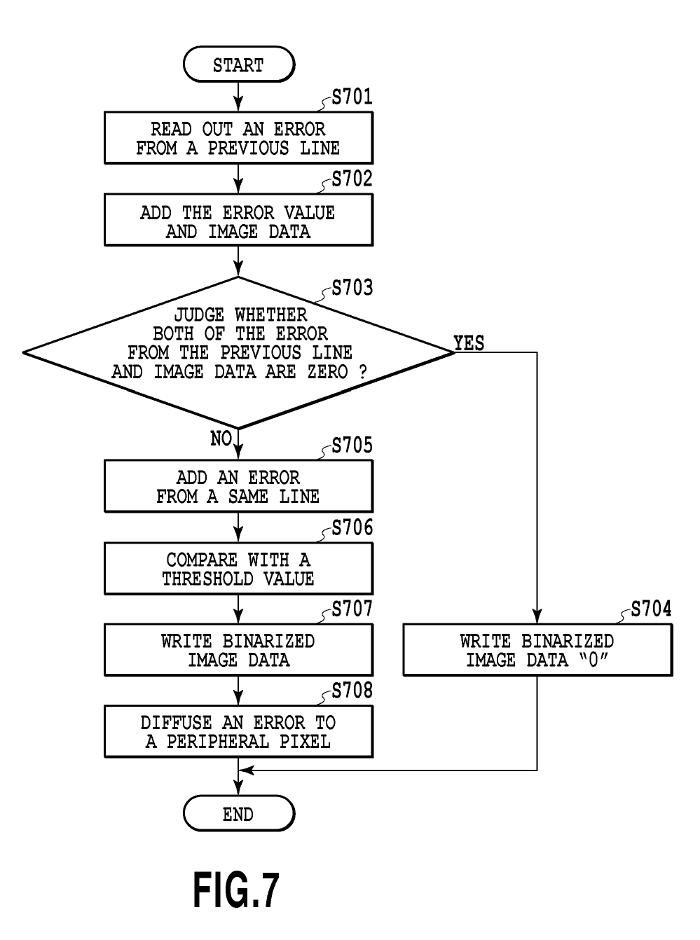

With reference to FIG. 7, quantization processing procedures at step S604 will be described in detail.

FIG. 7 is a flow chart illustrating detailed procedures of quantization processing. In the quantization processing, at step S701, the image processing unit 103 reads out a diffusion error from a previous line stored in the RAM 115 via the DMAC 208. Next, at step S702, the image processing unit 103 adds the error value read out at step S701 and image data (a pixel value of a pixel of interest). At step S703, the image processing unit 103 determines whether or not both of the input value P1 at step S702 and the error value P2 are 0 (zero). If the result of determination is NO (value≠0) (either one of them is not zero), the processing proceeds to step S705, where the image processing unit 103 adds, a diffusion error from a same line stored in the buffer 905 in the quantization processing unit 202, to the value of the step S702. At step S706, the image processing unit 103 compares image data to which a quantization error from a peripheral pixel is diffused with a threshold value stored in the register 204, thereby generating binary image data.

At step S707, the image processing unit 103 writes the generated binary image data to the RAM 115 via the DMAC 207. At step S708, the image processing unit 103 diffuses a generated quantization error to a peripheral pixel that is not quantized, according to a diffusion coefficient illustrated in FIG. 5, and terminates this processing. Of these quantization errors diffused at this step, a diffusion error to a same line is stored in the buffer 905 in the quantization processing unit 202. Meanwhile, a diffusion error to a neighboring line is once stored in the buffer in the error distribution unit 904, all diffusion errors to a predetermined pixel are summed up and then stored, as error data to a subsequent line, in the RAM 115 via the DMAC 209.

If the determination result at step S703 is YES (value=0) (an error of a previous line and a pixel of interest are both zero), the image processing unit 103 writes binary image data as zero to the RAM 115 via the DMAC 207 at step S704 without performing processing from S705 to S708. That is, without performing quantization processing by the quantization unit 903, a predetermined value, zero, is written to the RAM 115, as a result of binarization. By this, if an error value from a previous line is zero and a pixel value of a pixel of interest is zero, processing by the quantization unit 903 can be skipped, thereby allowing for high-speed processing. After that, if the pixel of interest is zero, an error of a previous line is also zero. Therefore, pixels for which quantization is not performed by the quantization unit 903 continue until a pixel value of a pixel of interest becomes greater or equal to one. Even after proceeding to a subsequent line, if quantization by the quantization unit 903 is skipped, an error value also becomes zero. Therefore, if a pixel of interest is zero, quantization by the quantization unit 903 continues to be skipped. Accordingly, for example, in a portion where a blank space continues at an outer edge of an image to be printed, quantization by the quantization unit 903 can be skipped continuously in this way, thereby allowing for high-speed processing as well as preventing image degradation. That is, if quantization processing is skipped, processing can be sped up by, for example, reducing access frequency to the RAM 115, and image degradation does not occur since a portion for which quantization is skipped is a blank space.

### Other Embodiments

In the aforementioned embodiments, the high-speed mode determination unit pays attention to a value of image data and an error value from a previous line to a pixel of interest, and moves to a high-speed mode to output a value that is not subjected to quantization and error distribution processing. This is because ignoring an error from a same line does not have much effect on image quality. In the following embodiment, an error from a same line is taken into consideration, thereby further improving image quality. The same explanation as the aforementioned embodiment will be skipped and differences will be described.

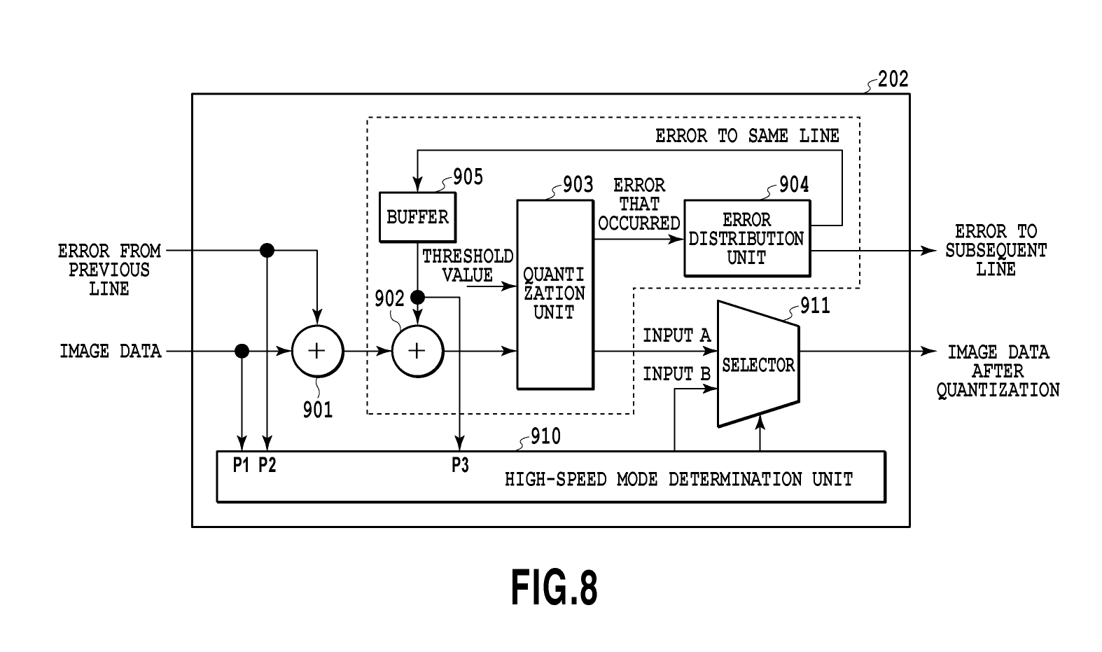

In FIG. 8, in addition to the configuration illustrated in FIG. 6, an error value P3 of a same line that is held in the buffer 905 is inputted. It is determined whether this error value P3 is zero or not. In the case where it is determined that the error value P3 is not zero, quantization by the quantization unit 903 is performed even if both of a pixel value P1 of a pixel of interest and an error value P2 from a previous line are zero. Accordingly, unless the error value P3 is zero, the selector 911 selects and outputs an output (input A) from the quantization unit 903. Meanwhile, if all of values P1 to P3 are zero, quantization by the quantization unit 903 is not performed and a predetermined value, zero, is outputted as a result of binarization. In this quantization processing, processing to read out an error (P3) from a same line out of the buffer 905 is added at a stage prior to S703 in the flow illustrated in FIG. 7, and at S703, it is determined whether all of P1 to P3 are zero or not. If it is determined that all are zero, processing from S705 to S708 is not performed and a predetermined value, zero, is outputted at S704 as a result of binarization. By this, if all of a pixel of interest, an error from a previous line, and an error from a same line are zero, quantization processing can be skipped, thereby allowing for high-speed processing as well as preventing image degradation.

In the aforementioned embodiments, a method for distributing error diffusion and the size and shape of a mask for error diffusion are not limited to the aforementioned values and forms. In the aforementioned embodiments, described are examples in which M-value image data is binarized. However, M-value image data may be converted to N-value image data (N is greater or equal to three values) (M>N). In the aforementioned embodiments, a portion that performs quantization is realized by ASIC, but quantization may be performed by software. That is, a program that operates according to a flowchart illustrated in FIGS. 5 and 7 may be stored in the ROM 117, loaded to the RAM 115, and executed by the CPU 102, thereby performing the same processing as the aforementioned embodiments. In this case, if both of a pixel of interest and an error from a previous line are zero, or if all of a pixel of interest, an error from a previous line, and an error from a same line are zero, quantization processing is skipped, thereby obtaining a result of converting N-values by error diffusion processing at high speed.

The aforementioned embodiments can be also realized by performing the following processing. That is, software (a program) that realizes a function of the aforementioned embodiments is supplied to a system or a device through a network or various storage media, and the program is read out and executed by a computer (CPU, MPU and so on) of the system or device. The program may be executed by one computer or a plurality of computers coupled to each other. The whole of the aforementioned processing is not necessary to be realized by software, but part or whole of the processing may be realized by hardware.

In the aforementioned embodiments, embodiments of an ink jet printing device are described, but devices in other formats such as a digital TV and an electrograph are also can be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-256004, filed Nov. 16, 2010, which is hereby incorporated by reference herein in its entirety.

What is claimed is:

1. An image processing apparatus comprising:
an input unit configured to input M-value image data;
a quantization unit configured to quantize a value of a pixel of interest in the image data inputted by the input unit to N(N<M) value by an error diffusion method;
a determination unit configured to determine whether or not both of a value of a pixel of interest to be quantized by the quantization unit and an error value to be added to the pixel of interest are zero; and
if the determination unit determines that both of the value of the pixel of interest and the error value are zero, an output unit configured to output zero as a quantization result without performing quantization by the quantization unit.

2. The image processing apparatus according to claim 1, wherein the determination unit determines whether or not both the value of the pixel of interest and an error value from a previous line are zero.

3. The image processing apparatus according to claim 1, wherein the determination unit determines whether or not the value of the pixel of interest, the error value from the previous line and an error value from a same line are zero.

4. An image processing method comprising:
inputting M-value image data;
quantizing a value of a pixel of interest in the inputted image data to N(N>M) value by an error diffusion method;
determining whether or not both of a value of the pixel of interest to be quantized and an error value to be added to the pixel of interest are zero; and
if it is determined that the value of the pixel of interest and the error value are zero, outputting zero as a quantization result without performing quantization by the error diffusion method.

5. A non-transitory computer-readable storage medium which stores a computer-executable program for performing a following method, the method comprising:
inputting M-value image data;
quantizing a value of a pixel of interest in the inputted image data to N(N>M) value by an error diffusion method;
determining whether or not both a value of the pixel of interest to be quantized and an error value to be added to the pixel of interest are zero; and
if it is determined that the value of the pixel of interest and the error value are zero, outputting zero as a quantization result without performing quantization by the error diffusion method.
